(19) United States
(12) Patent Application Publication
(10) Pub. No.: US 2015/0193898 A1
(43) Pub. Date: Jul. 9, 2015

(54) SYSTEM AND METHOD FOR PROVIDING AIRPORT SECURITY

(71) Applicant: HONEYWELL INTERNATIONAL INC., Morristown, NJ (US)

(72) Inventors: Vikram Huruli, Bangalore (IN); Sai Krishnan Mohan, Bangalore (IN); Ranga Udipi, Bangalore (IN); Chinmaya Kar, Bangalore (IN)

(73) Assignee: HONEYWELL INTERNATIONAL INC., Morristown, NJ (US)

(21) Appl. No.: 14/150,043

(22) Filed: Jan. 8, 2014

(51) Int. Cl. G06Q 50/26; G06Q 20/32; G06Q 20/10

(52) U.S. Cl. CPC G06Q 50/265; G06Q 20/10; G06Q 20/322

(57) ABSTRACT

A method and apparatus are provided for facilitating passage of a passenger through immigration, customs, and security at a destination airport. Immigration and customs forms are completed and assistance is requested by communicating either on-line or verbally with a port-of-entry (POE) and requesting assistance from the POE, using a hand-held, portable communication device, prior to landing at the destination airport.

### TECHNICAL FIELD

Embodiments of the subject matter described herein relate generally to systems and methods for providing airport security. More particularly, embodiments of the subject matter described herein relate to systems and methods for providing immigration, customs, and security clearances at airports while at the same time increasing passenger convenience.

### BACKGROUND

Generally speaking, air travel is not a pleasant experience, especially for the international traveler. Except for a general tightening of security after Sep. 11, 2001, little has changed. Delays and/or long lines are still encountered at arrival gates, multiple identification checks, immigration counters, and customs counters and inspections.

Certain piecemeal improvements have been attempted, and in some cases adopted. For example, there are programs that provide expedited entry by pre-approved, low-risk travelers. Participation in such programs generally require enrollment including supplying a great deal of personal information, payment of an enrollment fee, interviews, background checks, pictures, biometrics (e.g. fingerprints, palm vein pattern, iris scan, etc.), and the like. If approved, the individual is issued a smart identification card that may then be used to bypass customs and immigration lines. At some airports, global entry kiosks have been implemented to avoid waiting in lines. The completion of an on-line application is required, and it may take several weeks to schedule a required interview. In other locations, passport control kiosks, biometric e-gates, and/or self-service immigration through automated border control gates have been implemented.

Unfortunately, while achieving certain piecemeal improvements in specific aspects of the arrival process for international travelers, a completely expedited process beginning with pre-arrival procedures and extending through immigration and customs checks has yet to be developed and implemented.

Accordingly, it would be desirable to provide improved systems and methods for enhancing security, while at the same time increasing passenger convenience, when performing immigration, customs, and security clearances at airports. It would further be desirable to initiate such methods in a more convenient manner prior to aircraft landing. It would be still further desirable to utilize SATCOM device identification, sentiment analysis, and multi-modal biometric identification to facilitate immigration, custom, and security clearances at airports. It would also be desirable that the improved systems and methods provide (1) remote immigration and/or customs clearances before passenger arrival at the destination airport, (2) availability of immigration and/or customs forms to passengers having suitable mobile devices, (3) Kₐ band communications to airline passengers and airport systems, and (4) digitization of immigration and/or customs forms at the airport. The Kₐ band covers the frequencies of 26.5-40 GHz. i.e. wavelengths from slightly over one centimeter down to 0.75 centimeters. The Kₐ band is part of the K band of the microwave band of the electromagnetic spectrum. This symbol refers to “K-above”; i.e. the band directly above the K-band. The 30/20 GHz band is used in communications satellites, uplink in either the 27.5 GHz and 31 GHz bands, and high-resolution, close-range targeting radars aboard military airplanes.

Furthermore, other desirable features and characteristics will become apparent from the subsequent detailed description and the appended claims, taken in conjunction with the accompanying drawings and the foregoing technical field and background.

### BRIEF SUMMARY

Provided herein is a method for providing passage of a passenger through immigration, customs, and security at a destination airport comprising completing immigration and customs forms by communicating with a port-of-entry (POE) prior to landing at a destination airport using a hand-held, portable communication device.

An airport passenger security system is also provided and comprises a distributed port-of-entry (POE) immigration and customs processing, and a plurality of digitized customs and immigration forms accessible from the airport for completion while the passenger is still airborne using a hand-held mobile communication device.

Additionally, there is provided an improved method for providing passage of a passenger through a point-of-entry (POE) airport that includes gate counters, immigration counters, and customs counters. The method comprises receiving passenger immigration, customs, and multi-modal biometric data via a hand-held, portable SATCOM device from the passenger while the passenger is still airborne; providing the data to the gate counters, immigration counters, and customs counters; and validating the identity of the passenger at the gate counters, immigration counters, and customs counters using the multi-modal biometric data received prior to passenger landing.

### BRIEF DESCRIPTION OF THE DRAWINGS

A more complete understanding of the subject matter may be derived by referring to the following detailed description and claims when considered in conjunction with the following figures, wherein like reference numbers refer to similar elements throughout the figures: and

FIG. 1 is a block diagram of an aircraft in Kₐ band communication with a Port of Entry (POE) destination airport and a customs duty payment center in accordance with an exemplary embodiment;

FIG. 2 is a block diagram of a system for increasing passenger convenience when navigating immigration, customs, and security clearances at airports in accordance with an exemplary embodiment; and

FIGS. 3 and 4 are flow charts describing a method for increasing passenger convenience when navigating immigration, customs, and security clearances at airports in accordance with an exemplary embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. The preferred embodiments of the system and methods described herein represent an intelligent way to present information in an efficient manner so as to facilitate passage through customs and immigration.

As suggested previously, embodiments described herein increase security through the use of SATCOM device identification, sentiment analysis, and multi-modal biometric identification. That is, through the use of a SATCOM device, a passenger may communicate with POE support staff for assistance and/or submission of online immigration and customs forms. A unique identification code is assigned to the SATCOM device that is, in turn, used to identify and validate the passenger through flight number, seat number and the like. Sentiment analysis corresponds to the association and storage of the passenger's sentiments, emotions, and the like, that assist in the identification of the passenger. It provides a level of correctness and a level of a lie that serve as indices of validation. That is, video and audio analytics are leveraged to determine the probability of a truthful response. This is determined based on pitch and variations in voice, as well as gestures, direction of gaze (e.g. looking away), etc. Interviews may be conducted with passengers in flight and their responses screened before landing. Upon landing, passengers that exhibited a higher probability of untruthful responses may be interviewed by airport staff while the majority of passengers may collect their baggage and leave without personal interviews. More detailed presentations of the subject matter may be found in (1) Veronica Perez-Rosas, et al., “Utterance-Level Multimodal Sentiment Analysis”, Proceedings of the 51^{st} Annual Meeting of the Association for Computational Linguistics, Pages 973-982, and (2) Louis-Phillippe Morency et al., “Towards Multimodal Sentiment Analysis: Harvesting Opinions from the Web”, ICMI'11, Nov. 14-18, 2011, Alicante, Spain. Multi-modal biometric identification and analysis provides multiple options for the identification/validation of passengers. Facial recognition, speech recognition, retinal scan, fingerprints, etc. may be utilized. The results of the analysis may provide an indication the potential risk of a passenger possibly resulting in a determination at the arrival-gate, immigration, and/or custom counters that the passenger merits additional scrutiny (i.e. passenger exception processing).

Also as suggested previously, embodiments described herein also provide increase passenger convenience. That is, passengers may complete immigration and customs inquiries through voice based responses to questions before arrival at the POE. Unlike the situation where paper forms are employed, the passenger may make changes/corrections to their responses. A paper form would have to be completely repopulated. An initial validation of passengers would be completed while still onboard the aircraft using sentiment analysis reducing the time spent on the ground by customs and immigration officials to complete the validation process, thus reducing passenger waiting time at the customs and immigration counters.

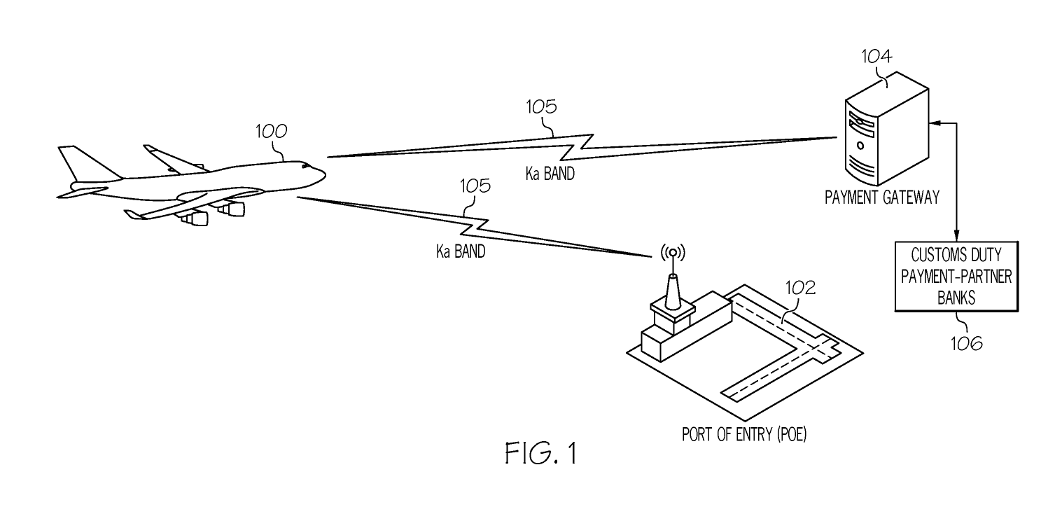

Turning now to the drawings, FIG. 1 is a graphical representation of an aircraft 100, a Port of Entry (POE) destination airport 102, a payment gateway 104, and a customs duty payment center 106 in accordance with an exemplary embodiment. Passengers on aircraft 100 may be in communication (e.g. utilizing Kₐ band communication links 105) via a mobile device (e.g. a portable electronic device such as a smartphone, tablet, or computing device carried by passengers) to complete immigration and customs inquiries, as above described. Passengers complete an online digital form-based and/or voice based immigration and custom process, declare and pay the customs duty, and if necessary, seek the assistance of the POE support staff to complete the forms. The POE staff provides confirmation of completion of the immigration/customs forms. In conjunction with the above, POE support staff validate the passenger by mean of the SATCOM device identification process by identifying/validating the passenger via flight number, seat number, and the like. Passengers may also communicate via the same device payment gateway 104 in order to pay any customs duty owed. The payment is forwarded to payment center 106 (e.g. partner banks)

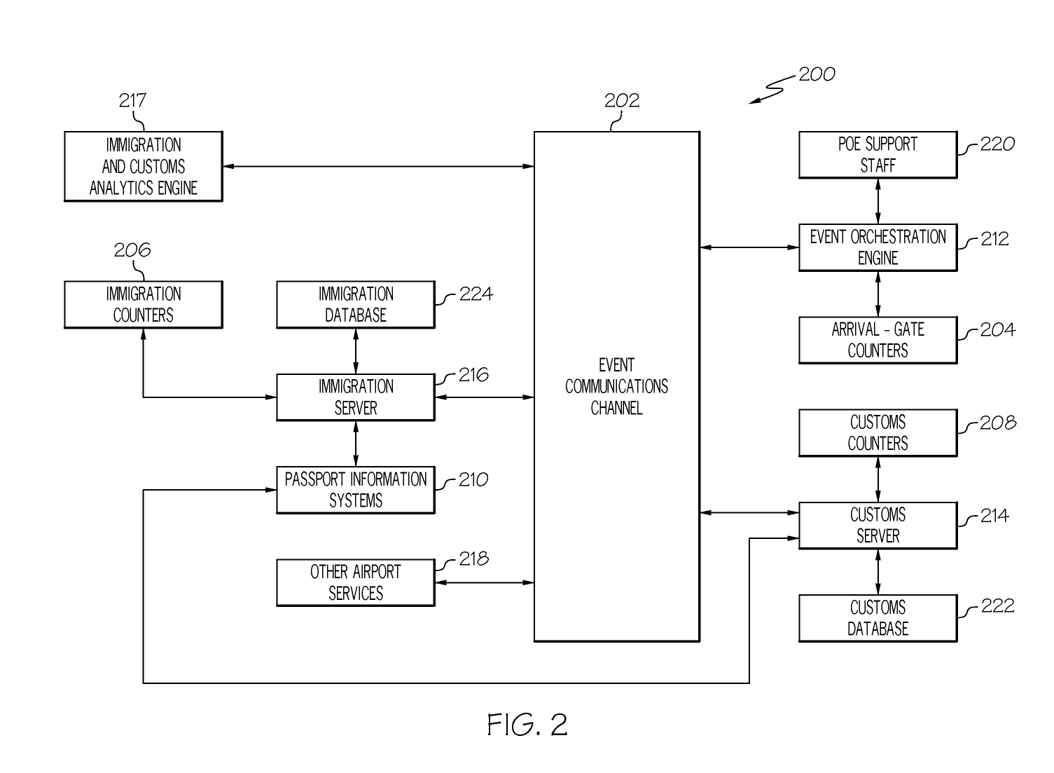

FIG. 2 depicts an exemplary system 200 for performing immigration, customs, and security clearances at airports in accordance with an embodiment. While the above described processes are being carried out, the passenger's audio responses are captures by the POE support staff and provided to and stored into the immigration and customs databases 222 and 224, respectively, and become accessible to the immigration and customs analytics engine 217 via event communication channel 202. The immigration and customs analytics engine 217 also carries out sentiment analysis based on the captured information; i.e. the emotions and sentiments of the passenger help identify the passenger.

Event communication channel 202 is an information bus that relays information between arrival gate counters 204, immigration counters 206, customs counters 208, and passport information systems 210. That is, a first processing unit, identified in FIG. 2 as event orchestration engine, is coupled for bilateral communication with event communication channel 202, a second processing unit identified in FIG. 2 as customs server 214, a third processing unit identified in FIG. 2 as immigration server 216, a fourth processing unit identified as immigration and customs analytic engine 217, and other airport services (e.g. shops, restaurants, tourism, concierge, or other vendor driven services on airport premises). Event orchestration 212 is also bilaterally coupled (coupled for two-way communication) to POE support staff 220 and arrival gate counters 204. Customs server 214 is also bilaterally coupled to customs counters 208, customs database 222, and passport information systems 210. Finally, immigration server 216 is also bilaterally coupled to immigration counters 206, passport information systems 210, and to immigration database

The architectures of the first, second, third, and fourth processors may utilize one or more known general-purpose microprocessors or an application specific processor that operates in response to program instructions. In the depicted embodiment, the processor architecture includes or communicates with RAM (random access memory), and/or ROM (read only memory). The program instructions that control the processor individual architecture may be stored in either or both the RAM and the ROM. For example, the operating system software may be stored in the ROM, whereas various operating mode software routines and various operational parameters may be stored in the RAM. It will be appreciated that this is merely exemplary of one scheme for storing operating system software and software routines, and that various other storage schemes may be implemented. It will also be appreciated that the processor architecture may be implemented using various other circuits, not just a programmable processor. For example, digital logic circuits and analog signal processing could also be used.

When a passenger arrives at the POE, a sentiment analysis is carried out at the arrival gate counters 204 to validate the passenger. Immigration and customs analytics engine 217 provides the sentiment analysis data to the arrival gate counters 204. In addition, multi-modal biometric identification and analysis is carried out at the arrival gate counters 204. Validation/identification is performed using multiple technologies; e.g. facial recognition, speech recognition, retinal scan, fingerprints, etc. Additional passenger biometric information may be available from the immigration database 224 and customs database 222 and will be analyzed.

If the passenger is not considered to represent a risk, the passenger proceeds to immigration counters 206. Here, additional biometric information is provided to the customs database 222 and the immigration database 224 with which the immigration and customs analytics engine 217 performs further analysis. Additional passenger validation is carried out at this point. The remaining customs formalities are also carried out at this point. If at this point the passenger is still not considered to represent a risk, then the passenger is considered to have successfully met all formalities and security checks at the airport. If, on the other hand, the passenger has been deemed to be a risk at this step or any previous steps, then the passenger would be subjected to additional processing.

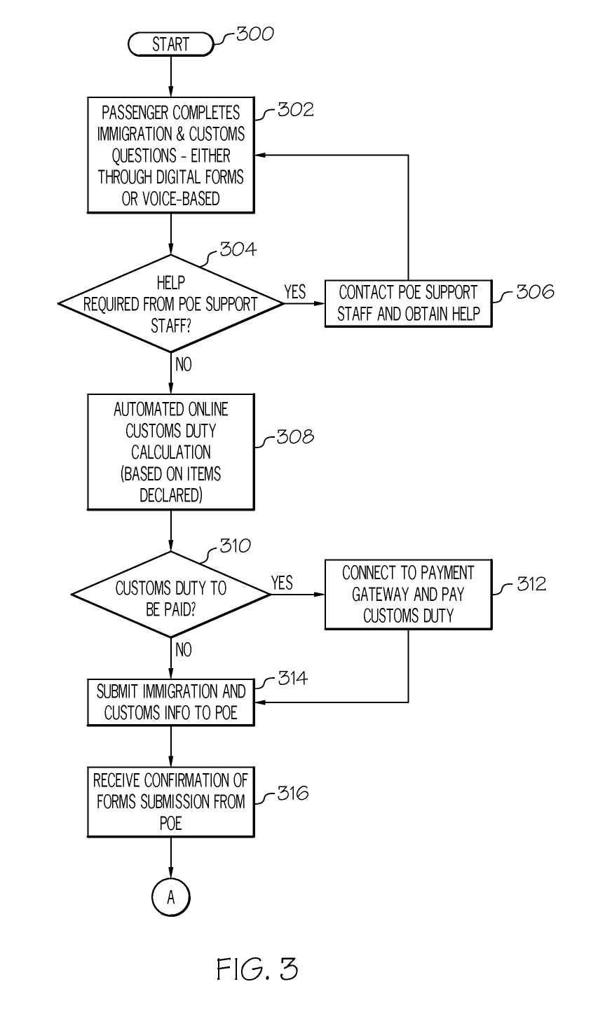

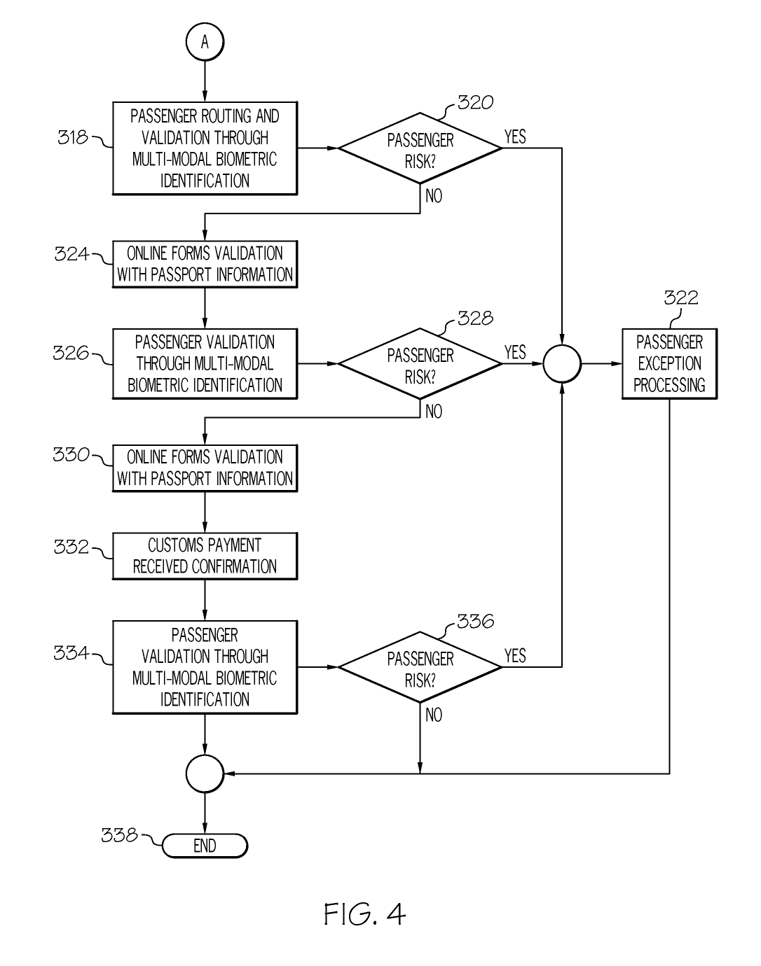

FIGS. 3 and 4 are sequential flow charts that illustrate an exemplary embodiment of a process 300 for providing immigration, customs, and security clearances at airports while at the same time increasing passenger convenience. The process begins while the passenger is still in flight by completing the immigration and customs forms either voice based or digitally by means of a digital mobile device; i.e. a SATCOM device (STEP 302). If assistance in completing the forms is required, POE support staff me be contacted for assistance (STEP 306). When the forms are completed, a customs duty is computed based on the items declared (STEP 308). If no duty is due, the immigration and customs information is submitted to the customs and immigration authorities. If a duty is due, the passenger is connected to a payment gateway (104 in FIG. 1). After payment is made, the passenger's customs and immigration forms are submitted to the customs and immigration authorities.

Upon landing and deplaning at a destination airport (POE), the passenger is subjected to multi-modal biometric identification (e.g. retinal scan, fingerprints, etc.) (STEP 318). If, as a result, it is determined that the passenger may represent a risk (STEP 320), the passenger is subject to further processing in STEP 322 (i.e. passenger exception processing). Otherwise, the passenger moves on to the immigration counters (206 in FIG. 2) where passport information and the data contained on the on-line forms are validated (STEP 324). Once again, the passenger is subjected to multi-modal biometric identification (STEP 326), and if the passenger is determined to represent a risk (STEP 328), the passenger is subject to further processing in STEP 322 (i.e. passenger exception processing).

If the passenger has not been identified as a risk, the passenger moves to customs counters (208 in FIG. 2) where passport information and the data contained on the on-line forms is again validated (STEP 330). After it has been established that any duty due has been paid (STEP 332), passenger identity is again validated using multi-modal biometric identification techniques (STEP 334). If the passenger is determined to represent a risk (STEP 336), the passenger is subject to further processing in STEP 322 (i.e. passenger exception processing). Otherwise, the passenger has met all security, immigration, and customs requirements and is free to leave the airport (STEP 338).

The various tasks performed in connection with the process 300 may be performed by software, hardware, firmware, or any combination thereof. For illustrative purposes, the following description of the process 300 may refer to elements mentioned above in connection with FIGS. 1 and 2. In practice, portions of the process 300 may be performed by different elements of the described system, such as the processing architecture or the display element. It should be appreciated that process 300 may include any number of additional or alternative tasks. The tasks shown in FIGS. 3 and 4 need not be performed in the illustrated order and may be incorporated into a more comprehensive procedure or process having additional functionality not described in detail herein.

Thus, there has been provided systems and methods for enhancing security, while at the same time increasing passenger convenience, when performing immigration, customs, and security clearances at airports. Such methods are initiated in a more convenient manner prior to aircraft landing. The systems and methods employ SATCOM device identification, sentiment analysis, and multi-modal biometric identification. Remote immigration and/or customs clearances are conducted before passenger arrival at the destination airport using immigration and/or customs forms made available to passengers having suitable mobile devices. Kₐ band communication is provided to airline passengers for the digitization of immigration and/or customs information at the airport.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for providing passage of a passenger through immigration, customs, and security at a destination airport comprising completing immigration and customs forms by communicating with a port-of-entry (POE) prior to landing at a destination airport using a hand-held, portable communication device.

2. The method of claim 1 further comprising:
requesting assistance from the POE; and
receiving the requested assistance from the POE via the hand-held, portable communication device.

3. The method of claim 1 further comprising communicating with the POE via a K^{a} band communication link.

4. The method of claim 1 further comprising:
determining a customs duty on-line via the hand-held, portable communication device over a Kₐ communication link with the POE; and
paying any payment owed via the hand-held portable communication device over a Kₐ band communication link via a payment gateway while still airborne.

5. The method of claim 1 further comprising submitting immigration and customs information to the port of entry.

6. The method of claim 5 further comprising receiving confirmation of receipt of the immigration and customs information from the POE while still airborne.

7. The method of claim 6 further comprising:
determining, at a POE arrival gate, if the passenger represents a risk based on biometric identification; and
identifying the passenger as requiring special processing if the passenger is deemed to represent a risk.

8. The method of claim 6 further comprising reconciling passport information at an immigration counter using information received while the passenger was still airborne.

9. The method of claim 8 further comprising
determining at the immigration counter if the passenger represents a risk based on biometric identification; and
identifying the passenger as requiring special processing if the passenger is deemed to represent a risk.

10. The method of claim 6 further comprising:
reconciling information at a customs counter using information received while the passenger was still airborne; and
confirming at the customs counter that any customs payment due was paid while the passenger was still airborne.

11. The method of claim 10 further comprising:
determining at the customs counter if the passenger represents a risk based on biometric obtained while the passenger was still airborne; and
identifying the passenger as requiring special processing if the passenger is deemed to represent a risk.

12. An airport passenger security system, comprising:
a distributed port-of-entry (POE) immigration and customs processor; and
a plurality of digitized customs and immigration forms accessible from the airport for completion while the passenger is still airborne using a hand-held mobile communication device.

13. The system of claim 12 wherein the communication device is a SATCOM device that enables Kₐ band communication between the passenger and the airport.

14. The system of claim 13 wherein the processing system further comprises:
an immigration and customs analytics engine that performs multi-modal biometric identification and sentiment analysis of passengers; and
an event communication channel coupled to the immigration and customs analytics engine.

15. The system of claim 14 wherein the processing system further comprises:
an immigration server coupled to the event communication channel;
an immigration database coupled to the immigration server; and
a passport information database coupled to the immigration server.

16. The system of claim 15 wherein the processing system further comprises a customs server coupled to the event communication channel and to the passenger information database.

17. A method for providing passage of a passenger through a point-of-entry- (POE) airport that includes gate counters, immigration counters, and customs counters, the method comprising:
receiving passenger immigration, customs, and multi-modal biometric data via a hand-held, portable SATCOM device from the passenger while the passenger is still airborne;
providing the data to the gate counters, immigration counters, and customs counters; and
validating the identity of the passenger at the gate counters, immigration counters, and customs counters using the multi-modal biometric data received prior to passenger landing.

18. The method of claim 17 further comprising:
determining a customs duty on-line via the hand-held, portable communication device over a Kₐ communication link with the POE; and
paying any payment owed via the hand-held portable communication device over a Kₐ band communication link with a payment gateway while still airborne.

19. The method of claim 18 further comprising receiving confirmation of receipt of the immigration and customs information from the POE while still airborne.

20. The method of claim 19 further comprising reconciling passport information at the gate counters, the immigration counters, and the customs counters using information received while the passenger was still airborne.
